(19) United States
(12) Patent Application Publication
(10) Pub. No.: US 2002/0013767 A1
(43) Pub. Date: Jan. 31, 2002

(54) Electronic funds transfer system for financial transactions

(76) Inventor: Norman Katz, Newbury Park, CA (US)

Correspondence Address: KOPPEL & JACOBS, Suite 107, 555 St. Charles Drive, Thousand Oaks, CA, 91360, US

(21) Appl. No.: 09/891,828

(22) Filed: Jun. 25, 2001

Related U.S. Application Data
(60) Provisional application No. 60/214,166, filed on Jun. 26, 2000.

(51) Int. Cl. G06F 17/60

(52) U.S. Cl. 705/39

(57) ABSTRACT

The present invention relates to a system for facilitating open electronic commerce and implementing secure, accurate, fast and cost effective electronic money transfers for financial transactions as an alternative medium of economic exchange to cash, checks, credit and debit cards and electronic funds transfer. A system for electronic funds tracking and payment, referred to as Cyber Credit money or CCmoney is described. The CCmoney system uses Cyber Credit money backed by the U.S. dollar and/or other real currency reserves to provide an electronic medium of exchange, store of value and de-facto legal tender.

This application is based on Provisional Application No. 60/214,166 filed Jun. 26, 2000, which is based on Disclosure Document Number 459,528 filed Jul. 23, 1999, both of which are entitled Internet Letter Credit System for Business Transactions.

### FIELD OF THE INVENTION

The present invention relates to a system for facilitating open electronic commerce and implementing secure, accurate, fast and cost effective electronic money transfers for financial transactions as an alternative medium of economic exchange to cash, checks, credit and debit cards and electronic funds transfer. A system for electronic funds tracking and payment, referred to as Cyber Credit money or CCmoney is described herein. The CCmoney system uses Cyber Credit money backed by the U.S. dollar and/or other real currency reserves to provide an electronic medium of exchange, store of value and de-facto legal tender.

### BACKGROUND OF THE INVENTION

Automation has achieved some of the desired qualities for large transactions through computerized electronic funds transfer (“EFT”) systems. Electronic funds transfer is essentially a process of value exchange achieved through the banking system's centralized computer transactions. EFT services are a transfer of payments utilizing electronic “checks,” which are used primarily by large commercial organizations.

The Automated Clearing House (ACH) and point of sale (POS) systems are examples of electronic funds transfer systems that have become used by retail and commercial organizations on a substantial basis in recent years. However, the payments made through these types of EFT systems are limited in that they can be performed only without extensive participation of the banking system. Moreover, ACH transactions usually can only be performed during regular business hours which results in significant delays in international transactions.

Home Banking bill payment services are examples of an electronic funds transfer system used by individuals to make payments. Currently, home banking initiatives have found few customers. Of the banks that have offered services for payments, account transfers and information over the telephone lines using personal computers, less than one percent of the bank's customers are using the service. One reason that Home Banking has not been a successful product is because the customer cannot deposit and withdraw money as needed in this type of system. The invention allows users to receive and send virtual money instantly convertible to checking deposits or withdrawals using nothing more the a simple computing device like a home computer or other device connected to the Internet.

Current EFT systems, credit cards, or debit cards, which are used with an on-line system to transfer money between accounts, such as between the account of a merchant and that of a customer, cannot satisfy the need for an automated transaction system that provides for the transfer of universally accepted economic value outside of the transaction by transaction participation of the banking system. Moreover, credit and debit card systems are generally not adequately secured against fraud and do not provide for adequate privacy.

To implement an automated, yet more convenient transaction system that does not require the banking system to intermediate each transfer, and that can dispense some form of economic value, there has been a trend towards off-line electronic funds transfer. For example, numerous ideas have been proposed for some form of “electronic money” that can be used in cashless payment transactions as alternatives to the traditional currency and check types of payment systems. See U.S. Pat. No. 4,977,595, entitled “Method And Apparatus For Implementing Electronic Cash,” and U.S. Pat. No. 4,305,059, entitled “Modular Funds Transfer System.”

One method of anonymous payment is described in U.S. Pat. No. 5,453,601 entitled “Electronic-Monetary System” issued Sep. 26, 1995. That application discloses an electronic monetary system for implementing electronic money payments as an alternative medium of exchange to cash, checks, credit cards, debit cards, and electronic funds transfers. In particular, the described system uses money modules packaged in tamper-proof housings to store and transfer electronic notes. Money module payments may be either real-time, off-line payments between money modules (e.g., between a money module contained within a customer's “electronic wallet” and a money module contained within a merchant's point-of-sale terminal), or on-line payments for network services such as information retrieval and telephone calls, or for purchasing airline tickets, theater tickets, etc.

However, these proposed systems suffer from a failure to recognize fully the significance of bank deposits as money, and their necessity to back any form of universally accepted monetary representations that may be issued. In these systems representations of economic value, whether electronic or paper, are issued without the backing of equal valued liabilities as the counterpart to their assets.

In U.S. Pat. No. 5,453,601 an electronic monetary system (EMS) is described which provides an electronic money system which utilizes electronic money that is interchangeable with traditional cash and is universally accepted. That patent provides a method and system for securely transferring economic value including currency and credit among subscribers, among financial institutions, and between subscribers and financial institutions. The EMS also provides for electronic money in the form of multiple currencies.

US Pat. Nos. 5,557,518 and 5,799,087 provide enhanced EMS systems and related methods for economic exchange that is secure from reuse, duplication and counterfeiting.

U.S. Pat. No. 5,557,518 uses trusted agents and money modules to create a system for open electronic commerce where both customers and merchants can securely transact remotely over electronic networks without prior knowledge of each other.

According to one aspect of the '518 patent, a customer trusted agent establishes a cryptographically secure session with a merchant trusted agent. The customer trusted agent securely communicates with a first money module, and the merchant trusted agent securely communicates with a second money module. The merchant trusted agent delivers electronic merchandise that is provisionally retained by the customer trusted agent. The trusted agents participate in a secure dialogue and mutually agree on the payment terms. The first money module transmits electronic money to the second money module. Upon successful completion of the money module payment, the first money module informs the customer trusted agent, and the second money module informs the merchant trusted agent. The merchant then logs the sale and the customer may use the purchased electronic merchandise.

The '087 patent describes an electronic-monetary system having (1) banks or financial institutions that are coupled to a money generator device for generating and issuing to subscribing customers electronic money including electronic currency backed by demand deposits and electronic credit authorizations; (2) correspondent banks that accept and distribute the electronic money; (3) a plurality of transaction devices that are used by subscribers for storing electronic money, for performing money transactions with the on-line systems of the participating banks or for exchanging electronic money with other like transaction devices in off-line transactions; (4) teller devices, associated with the issuing and correspondent banks, for process handling and interfacing the transaction devices to the issuing and correspondent banks, and for interfacing between the issuing and correspondent banks themselves; (5) a clearing bank for balancing the electronic money accounts of the different issuing banks; (6) a data communications network for providing communications services to all components of the system; and (7) a security arrangement for maintaining the integrity of the system, and for detecting counterfeiting and tampering within the system.

The electronic money exchanged may be an electronic representation of currency or credit. The electronic currency is the equivalent of bank notes and is interchangeable with conventional paper money through claims on deposits in an issuing bank, but can be withdrawn or deposited both at an issuing bank and at a correspondent bank. However, only the issuing banks can generate the electronic currency, and will be liable for its redemption.

The issuing banks later utilize inter-bank clearing and settling processes to maintain the monetary balance in the banking system, as is currently practiced by today's banking industry.

The electronic money of the '087 patent are intended to be fungible, universally accepted, and undeniably redeemable from the issuing banks, i.e., they have the characteristics of money transactions. To preserve the integrity of the electronic monetary system, each exchange of electronic money includes, along with other information, data identifying the monetary unit of the credit or currency, (i.e., dollars, yen, etc.) the amount by unit of credit or currency, the bank issuing the electronic credit or currency, and several digital signatures.

The electronic monetary system of the '087 patent provides for transactions utilizing electronic money including electronic currency backed by demand deposits in a bank in lieu of cash transactions, and electronic credit authorizations. In one embodiment, the EMS comprises a money module for generating the electronic money; a money module for issuing, distributing, and accepting the electronic money; and a money module for accepting, storing, and transferring the electronic money between other accepting money modules and between the accepting money module and the issuing money module.

The electronic monetary system for implementing and maintaining electronic money includes electronic currency that is interchangeable with conventional money through claims on deposits in a bank and electronic credit authorizations.

The '087 system requires a plurality of issuing banks; a generator module for creating electronic money; teller modules coupled to the generator modules, for performing teller transactions and for interacting with other teller modules, such transactions including the accepting and the distributing of the electronic money; a security system for providing the overall integrity of the electronic monetary system; a clearing and settling process for balancing the electronic money accounts of the separate issuing banks and for clearing the electronic money issued by the issuing banks; and a plurality of transaction modules owned by authorized users, for transferring the electronic money between the transaction modules and between the transaction modules and the teller modules; and a customer service module handling lost money claims and for linking accounts to money modules to provide bank access. The electronic money exchanged by these modules, which may be an electronic representation of currency backed by demand deposit accounts at the issuing bank or credit authorizations, may be transmitted with digital signatures to provide security from unauthorized modification or counterfeiting.

None of these proposed paperless payment systems are comprehensive enough to implement a multipurpose electronic monetary system that includes not only the automated devices that allow subscribers to transfer electronic funds or money between participants without the transaction by transaction intermediating of the banking system, but that also encompasses and includes an entire virtual banking system for generating the value represented by the electronic money and for clearing and settling the electronic money accounts of the banks and financial institutions involved to maintain a monetary balance within the real money banking system.

Thus, there is a need for a system that allows common payer to payee economic exchanges without the intermediation of the banking system, and that gives control of the payment process to the individual. Furthermore, a need exists for providing a system of economic exchange that can be used by large organizations for commercial payments of any size that does not have the limitations of the current EFT systems.

Presently, money transfers are slow. A wire transfer can take from 5 hours to 5 days. The system described herein uses the Internet and takes advantage of its ability for almost instantaneous communication of business transactions. However, the Internet, like any country, needs its own currency. The described system creates Cyber Credit money which is a medium of exchange for Internet transactions. Cyber Credit money is based on any desired currency and is backed, unit for unit by, for example, the U.S. dollar (or any selected currency, i.e. British pound, German mark, Japanese yen, etc.) and freely convertible into U.S. dollars (or any selected currency). This allows CCmoney to offer, among other services, instantaneous services for:

Secure payments and overseas transfers,

Interactive letter of credit and loan repayment assurance,

Currency trading and transfers, and

A system classified directory augmenting customer and indirectly bank connectivity.

Transactions processed by the present invention will be instantaneous and convenient. The invention will have the capability of operating with every country's currency denominated instantly into the corresponding country's Cyber Credits, the operating virtual currency for circulation in the CCmoney system. As a result, for each specific country's Cyber Credit in circulation in the CCmoney system, there will be one real money currency unit in a distributed network of bank reserve deposits. The system further provides the capability for users (buyer and sellers) to deal directly with each other and complete a transaction without the need for an intervening agent or access, either directly or electronically with banking facilities other than to set up and fund Cyber Credit accounts. In addition to allowing transactions that can not now be completed in the real money banking system, the invention allows completion of any transaction that can now be consummated in the real money banking system to be replicated in the CCmoney virtual banking system.

The foregoing objects and advantages of the invention are illustrative of those, which can be achieved by the present invention and are not intended to be exhaustive or limiting of the possible advantages which can be realized. Thus, these and other objects and advantages of the invention will be apparent from the description herein or can be learned from practicing the invention, both as embodied herein or as modified in view of any variations which may be apparent to those skilled in the art. Accordingly, the present invention resides in the novel methods, arrangements, combinations and improvements herein shown and described.

### BRIEF DESCRIPTION OF THE DRAWINGS

Additional aspects, features, and advantages of the invention will be understood and will become more readily apparent when the invention is considered in the light of the following description made in conjunction with the accompanying drawings, wherein:

FIG. 1 is a flow diagram of a system, incorporating features of the invention, for converting various currencies to cyber credits and transacting business using those cyber credits.

FIG. 2 is an expanded schematic representation of the interface between the users and the Central Controller portion of FIG. 1.

FIG. 3 is an expanded schematic representation of the interface between the Central Controller CPU and the various processors shown schematically in FIG. 1.

FIG. 4 is an expanded schematic representation of the interface between the users and the system for various transactions.

FIG. 5 is an expanded schematic representation of the generation of a letter of credit and the formation and release of related encumbrances.

FIG. 6 is an expanded schematic representation of the funds processor.

FIG. 7 is an expanded schematic representation of the new accounts generator.

FIG. 8 is an expanded schematic representation of a currency demand transaction.

### DETAILED DESCRIPTION

As a result of the growth and economic demand of the Internet, there is now a growing need in business for an Internet based universal electronic money system. Cyber Credit money, utilizing Internet access (CCmoney.com) is provided as a primary medium of exchange, store of value and defacto legal tender for transactions facilitated through the Internet. According to a Fortune magazine article, $1.4 trillion in annual Internet transactions will be reached by 2003. 90% of these will be business to business transactions. Cyber Credits, at all times, are linked, as described below, to the international, regional and local electronic banking systems. Links to participating banks are established for redemption of Cyber Credit balances for payment of taxes, payroll or any other transaction which can not be effected on the Internet. The process described herein is a seamless system for buying and selling almost anything on the Internet and effecting funds transfer for that transaction.

One of the major costs associated with international transactions is the cost of currency translation and the cost of hedging against potential unfavorable conditions. CCmoney.com allows users to better manage these costs and reduce the option premiums now associated with exchange rate hedging.

In international trade today, a buyer or a seller must decide to accept or make payment in a foreign currency. This is a multi-step process which consumes much time, effort and money and creates uncertainties in international transactions. CCmoney, by providing the means of storing in the Internet a strong internationally accepted electronic currency simplifies this process, reduces the risk and facilitates trade.

For developing economies, such as Russia's, where there is historical distrust of the national currency, Cyber Credits can be a safe and preferred currency. The preference to hold Cyber Credits may even be stronger than the preference to hold U.S. dollars because of its convenience.

As the CCmoney system strengthens, the need to redeem Cyber Credits into local currency will diminish and may, to the extent nations adopt Cyber Credits as augmentative legal tender, eventually disappear.

The system described herein provides a fast, secure and convenient method for individuals and businesses to conduct financial transactions without resorting to conventional methods of converting and transferring currencies between the various parties. Presently, business transactions must either be done by COD, credit (or debit) card, extension of credit by the seller, or by letter of credit. All of these methods are slower, more cumbersome than using the CCmoney system and considerably more subject to business risk and fraud. The CCmoney system also enhances confidence in use of the Internet as a business tool and will accelerate the pace of electronically based business transactions worldwide. The parties conduct business as if they were dealing face to face, ship goods and/or provide services in the normal course of business and exchange payment in the form of cyber credits as if both parties were dealing in the local currency and payment is made from hand to hand. The basic difference is that the transaction is conducted over the Internet and payment is handled electronically.

With respect to the CCmoney users, the Central Controller is in effect a wholesale supplier to banks which act as retailers to the users. In other words, the Central Controller is an outsourcing ASP portal to bank customers. From a bank's point of view, the central control of the CCmoney system will look very much like an administrator of a credit card system (i.e., Visa, Mastercard, American Express, etc.).

There are three main advantages to the CCmoney system for participating banks:

a) The bank will be able to reduce its staffing cost for check clearing, wire transfer and electronic transfer transactions as more CCmoney transactions take their place because CCmoney transactions are entirely controlled by the users without the services of intermediary bank personnel;

b) The bank can charge transaction fees to sellers and buyers for interactive letters of credit (encumbrances written by buyers) in excess of the CCmoney transaction fees to the bank, and charge spreads for currency transactions converting from Cyber Credits to other currencies and from other currencies to Cyber Credits in excess of the CCmoney spread rates;

and,

c) Over time, as the CCmoney system is adopted throughout the world, bank transaction growth rates will increase pushing bank profits toward geometric growth.

In the classic economic formula, MV=PT, where M=the amount of all money in circulation, V=velocity or the number of times that money supply turns over in a period of time, P=the average price of all goods and services exchanged in that period of time and T=the total number of transactions in that period of time, CCmoney will dramatically increase T thereby causing V to increase. In fact, downward pressure on P may also result. Since M is fixed by the fact that Cyber Credits are pegged to central bank currencies, there will be an accelerator effect in the world economy as a result of the system. As a result, because of the marginal utility of the CCmoney system compared to the present system, Cyber Credit accounts will spread virally throughout the Internet world economy. CCmoney's Central Controller does not incur any currency translation risk as it serves solely as an administrator of the system. Cyber Credits are always bought and sold by CCmoney users at the currency exchange rate then in effect for whatever currency is bought or sold. For each unit of a currency's Cyber Credits in the CCmoney system there will always be one unit of that currency on deposit as a reserve in a distributed network of participating banks around the world. A user's Cyber Credit account is linked to the user's checking (or check drawing savings or other check drawing account, i.e. stock or bond collaterized account, line of credit, etc. at a participating bank for purchase and redemption of Cyber Credits. An additional function of the Central Controller is to act as an escrow service providing an electronic letter of credit service. As part of the services provided to the participating banks, Central Control also operates a once a day inter-bank transfer to balance a bank's currency reserves with that specific bank's customer Cyber Credit balances at the end of each banking day.

The participating bank or its designated trust company acts as trustee for reserves held by each bank for the benefit its CCmoney customers. However, the Central Controller has authority to equalize the trust account with the bank customers' aggregate Cyber Credit balance on a daily basis. The trustee may verify or audit these transfers by comparing information supplied automatically or on demand by the CCmoney system with the bank's positive confirmation results for its CCmoney customers.

CCmoney or Cyber Credits are merely electronic records of hard currency assets which have been transferred from the control of the user to the trust reserve account of the user's bank to secure the user's issued Cyber Credit balance in the CCmoney system. Cyber Credits are not currency. The Cyber Credit in an account represents a packet of data processing services. CCmoney or Cyber Credits are not securities and therefor not subject to regulation by the SEC. A Cyber Credit is not an investment in CCmoney or any organization and therefore does not represent stock in a company. Further, it is not an electronic certificate of beneficial interest in the reserve trust account requiring registration under the 1933 Securities Act because a user does not purchase a Cyber Credit with the expectation of deriving a return primarily through the efforts of others. Therefor there is no “investment contract”.

Cyber Credits can be bought for any local currency that is traded; i.e. ICC's would connote Israeli Cyber Credits backed by New Israeli Shekels, FCC's would connote French Franc Cyber Credits, BCC's would connote British Pound Cyber Credits, JCC's would connote Japanese Yen Cyber Credits, etc. For purposes of simplicity and illustration, Cyber Credits are, unless otherwise indicated, described herein as being backed by U.S. dollars.

Cyber Credit are purchased for dollars or dollar equivalents; i.e., with foreign currency at the exchange rate then in effect and a record of such purchase is made in a Cyber Credit Account. One Cyber Credit is equal in value to one U.S. dollar. The value is backed by U.S. dollar reserves in a distributed network of participating banks around the world. For each Cyber Credit in circulation in the system, there will always be one U.S. dollar deposited in a reserve account some where in the system.

The back office software of CCmoney links Cyber Credit Accounts with bank checking accounts (or other selected money accounts). This allows for instantaneous free conversion of Cyber Credits into dollar deposits and dollar deposits into Cyber Credits. For example, dollars in a checking account can be used to purchase Cyber Credits to facilitate dollar denominated payments and international transfers.

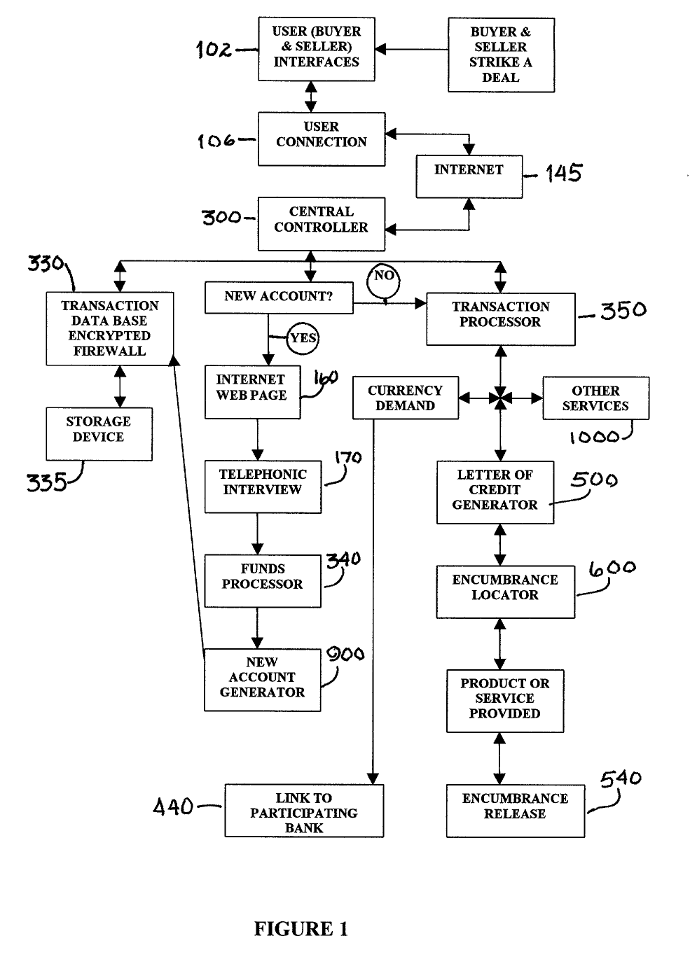

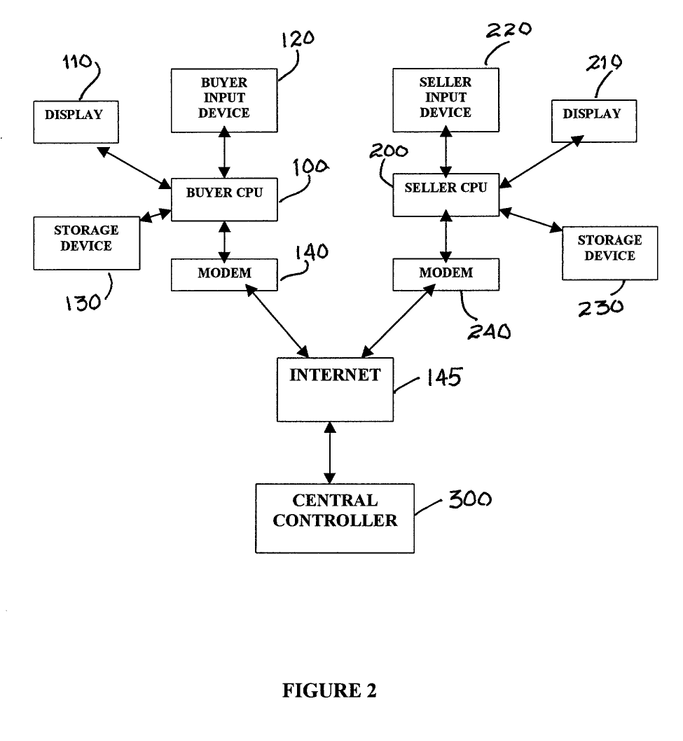

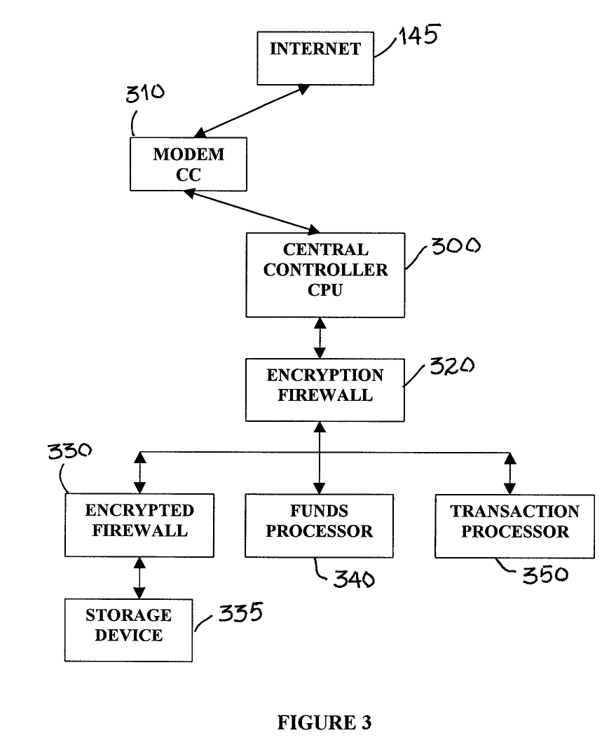

FIG. 1 is a flow diagram showing a representative process for converting various currencies into a system generated electronic intermediary currency, (cyber credits), for the subsequent creation of letters of credit and to facilitate electronic transactions between buyers and sellers. Once the buyer and seller connect and strike a deal the parties establish or access their respective cyber money accounts as is appropriate to move the transaction forward. The user of the system, either a buyer or seller of goods or services, through a user interface or input device, also referred to respectively as the buyer and seller input device 120, 220, user CPU 104 (buyer and seller CPU 100, 200) and user modem or other Internet connection 106 (buyer and seller 140, 240) connection, accesses the Internet 145. The user interface, more fully described in FIG. 2, displays, records, classifies and summarizes the transaction for the user. The buyer and seller input device 120, 220 includes typical computer components including buyer and seller display 110, 210 and buyer and seller storage devices 130, 230. The user(s) are then, in turn, connected, through the Internet 145 to the specialized electronic intranet which includes the CCmoney Central Controller 300, schematically shown in FIGS. 2 and 3.

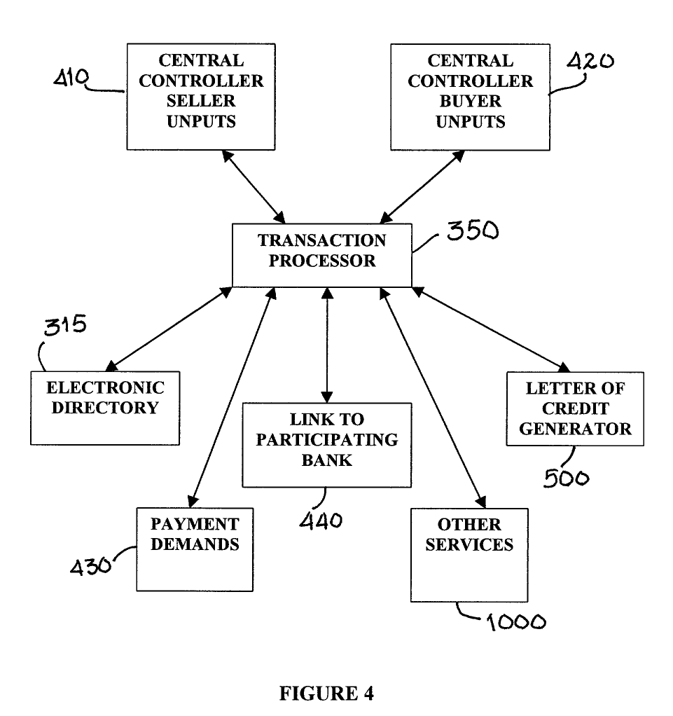

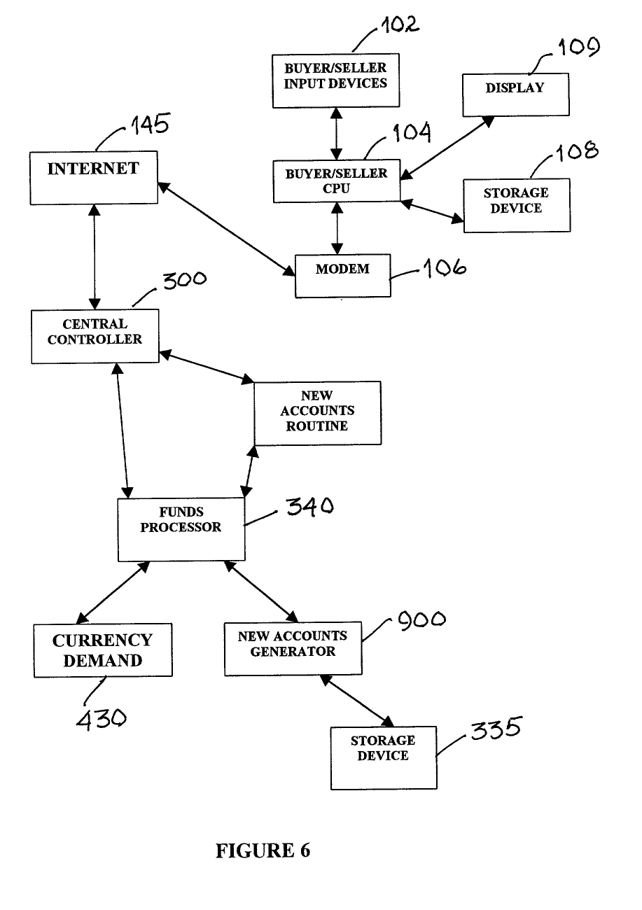

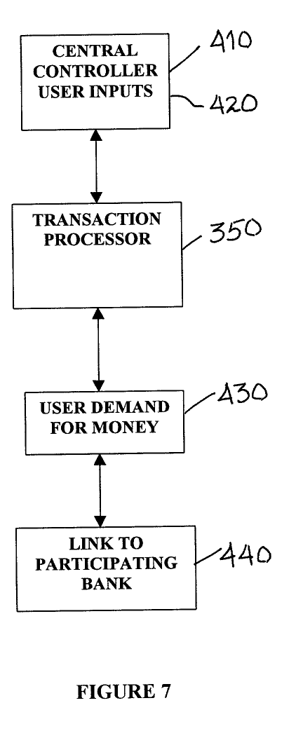

The Central Controller CPU 300 is programmed to handle all of the transactional matters necessary to open new accounts, record, classify and summarize all transactions and encrypt and store the recorded information in a manner that prevents unauthorized access, disclosure or theft of recorded information or users cyber credits. As best shown schematically in FIG. 3, the information delivered to the Internet 145 by the user passes through a CC modem 310 to the Central Controller CPU 300 and then through an encryption firewall 320 to a funds processor 340, schematically shown in FIG. 6 and/or a transaction processor 350, schematically shown in FIG. 4. The record of the processed cyber credit transfer and/or business transaction is then recorded in a typical electronic data storage device 335 which is behind an encrypted firewall 330.

The Central Controller CPU 300 first determines if the inquiry is a new account or other services or assistance is required. If it is, a new account, through an interactive web page 160, assisted by telephonic or electronic voice communication 170, a new account generator 900 establishes the new account with a unique user address and access code. The funds processor 340 receives funds in any system-acceptable currency and converts that currency to cyber credits for use in electronic transactions which are handled by the transaction processor 350 (see FIG. 4).

The voice interface 170 also serves to prevent money laundering, provide help to users in effecting transactions and aid in providing other services required by buyers and/or sellers. This also includes dispute resolutions and settlement of accounts.

If both parties have accounts or once accounts are established for both parties, the transaction processor 350 is accessed and the financial portion of the transaction proceeds. Electronic letters of credit, through the letter of credit generator 500, or encumbrances are applied to an account and verified, through the encumbrance locator 600, or other services 1000 are accessed. Once the seller or service provider delivers the goods or services, the buyer again accesses the encumbrance locator 600, through the Central Controller CPU 300, releases the encumbrance which automatically and instantaneously debits the buyer's CCmoney account and credits the seller's CCmoney account, completing the transaction. Paper or electronic records of the transaction can be generated by each party for retention as necessary for financial records and reporting requirements. As required, quarterly, annual and/or categorized records can also be generated in the same manner as with currently available, software based checking and credit card payment systems.

Additional services available through the transaction processor 350 allow a user to access his own account for the payment of other business expenses (referred to as payment demands 430) such as local and federal taxes, wages and salaries, paper or electronically received bills for normal business expenses such as monthly telephone, water, gas and electric services and similar expenses, travel expenses, credit card charges, etc. It is contemplated that the system will be expanded to meet the growing needs of users for other financial services, money transfer services or other related business services not presently defined. This is readily accomplished by adding new software modules for other services 1000 to the transaction processor 350.

Referring to FIG. 2, the Buyer CPU 100 and Seller CPU 200 are central processing units or other similar input means at the buyer and seller facilities for receiving, routing, temporarily storing and responding to digital signals generated by input devices, performing, as a result of such signals, computations or logical thought-like operations according to programmed digital or analog instructions and communicating the results thereof to display and/or more permanent storage devices.

Buyer and seller displays 110, 210 include the ability to provide a video display of data and information as well as having the capability of providing interactive audio communications and real time visual images to be dynamically or interactively displayed or a document to be printed.

Buyer and seller input devices 120, 220 are typically keyboard, mouse, card reader, scanner, voice recognition equipment, biometric equipment or other means for converting analog and/or mechanical energy into CPU readable digital signals.

Buyer and seller storage devices 130, 230 receive digital signals from the CPU, storing those signals on a medium that will preserve the signals when the power is off and allowing access to the stored signals and their modification by the CPU.

Buyer and seller modems 140, 240 transmit digital signals received from the CPU or receive digital signals to or from other modems.

The user interface 102 is the front end of the whole system. It is the only part that users of the system see. Only the cyber credit system managers and operators see the back end of the system. There are basically only two major functions that are of concern to both the front and back end of the system. These are the new accounts function and the transactions function. The basic distinction between buyer and seller input components are the nature of the transactions function. For purposes of describing the front end new accounts system, this distinction is not relevant. However, buyers are sometimes sellers and sellers are sometimes buyers and therefore the descriptions provided herein depend on the purpose of the user when he accesses the system.

In a front end new accounts operations, a user's desire to open a CC money account is expressed using an input device 120, 220. The signal generated by the input device causes the CPU 100, 200 to communicate through a modem 140, 240 with the web page of the back end system located in the Internet 145. The web page will then appear on the display 110, 210 and will request necessary information and action instructions such as the transfer of funds from a bank account. At various points in the interview dialogue, the user will indicate what sort of biometric security input device, encryption system or password will be used. The CC system will maximally accommodate the authorization regime of the user. The user will then download a scrambler and encryption generator unique to a specific machine or specific machines within the user's organization. Finally a unique identification code (CC money account address) will be assigned to the new user. All accounts being opened with an initial balance in excess of a specified amount will be telephonically interviewed by a CC operator trained to screen for money laundering transactions. This person will also be available to help new users get their accounts established. All inputs of the user in response to the web page interviewer are communicated through the Internet to the Central Controller which automatically controls the web page interviewer.

Once a user has established a CC money account, he or she can act as a buyer or seller in a transaction with another party who also has an established account. By telephone, facsimile, e-mail, auction web site or other means of communication, the buyer and seller come to an agreement. They can then use the CCmoney system to consummate the deal they have struck. In the typical case, the buyer will activate an encumbrance routine by using input device 120 to select an instruction from display 110. The amount of the encumbrance will be equal in cyber credits to the agreed upon price in the contracted currency. Once the CCmoney account of the buyer has been encumbered in favor of the seller, the amount of the encumbrance in the buyer's CCmoney account is impounded and can not be used for any purpose other than making payment to the seller. The amount can only be reduced with the participation of the seller, by court order or, in rare instances of fraud, by intervention by the management of CCmoney system. However, in the typical case, the seller will use an input device 220 to search for the buyer's encumbrance. Once it appears on the display 210, the seller can acknowledge the order by entering text using the input device 220. When the seller fulfills his commitment, the buyer will call up the encumbrance from the storage device 130 using the input device 120 to appear on display 110. Then using the input device 120, the buyer will release the encumbrance causing the transfer of the corresponding cyber credit amount from buyer's CCmoney account to the CCmoney account of the seller. The buyer CPU 100 facilitates these operations and automatically activates the modem 140 to communicate through the Internet 145 to the Central Controller 300 that the encumbrance has been released. The seller receives instant credit and is able to verify the transfer by using the input device 220 to access the storage device 230 which is automatically updated by the Central Controller CPU 300 through the Internet 145 whenever the modem 240 is connected to the Internet. Once the seller CPU 200 locates the transfer, it transmits the information to display 210.

The modem 310 connected to the Central Controller CPU 300 may likewise be a cable modem, fax modem DSL modem or any means for receiving the signals generated by the front end system. These signals, which are scrambled and otherwise encrypted, are transmitted to the Central Controller CPU 300. The CPU 300 decrypts the signal and determines its disposition in the back end system. The signal is then re-encrypted by encryption firewall 320.

The encryption firewall 320 creates encoded signals which would be unintelligible to an unauthorized computer breaking into the system. Signals dealing with new accounts are routed through the new accounts routine and funds processor 340 Information requiring storage is transmitted by transaction processor 350 and dynamically encoded by encrypted firewall 330 which is an encoder whose code continually changes to make it more difficult for an intruder to decode stored information. The funds processor 340 handles the receipt of all money transfers and currency trades while the transaction Processor 350 routes all transaction requests to the desired operational module.

The user demand module (payment demands) 430 responds to requirements for translation of cyber credits into money needed by the user for settlement of certain business obligations which require the delivery of legal tender. For example, a U.S. multi-national company may need French Franks deposited in its bank account in Paris to pay French taxes. In such an instance, the transaction processor 350 recognizes encrypted signals from the seller or buyer Central Controller inputs 410, 420 as instructions for funds transfers or creation or modification of interactive letters of credit through the LC Generator or, if an instruction for funds transfer is given, an input to the link to a participating bank 440.

The link to a participating bank 440 causes funds on deposit for the system at a participating bank to be transferred to the user's bank. This can be done in whatever traded currency the user requests and wherever the user maintains an account with a corresponding participating bank.

The letter of credit generator 500 causes an encumbrance as written by a buyer to be recorded against the buyer's CCmoney account and enables verification by the seller that such a record has been irrevocably established.

A transaction processor buyer input 520 constitutes a purchase order and assurance of payment in the form of an encumbrance against the buyer's cyber credit balance. Once established as an encumbrance, that specific CCmoney can not be used for any other purpose than to pay the seller and can not be reduced without the seller's authorization, a court order or, in the rare instance of a failure by the buyer to release encumbered funds, by the system operator finding in favor of the buyer.

A buyer input 520 causes the establishment of a letter of credit by the letter of credit generator 500 which stores that record in the Central Controller's storage device 335. This record has an encrypted identifier, which allows the seller to verify that the encumbrance record is in place. The encumbrance record and its identifier can then be accessed using the encumbrance locator 600.

Likewise, the transaction processor for seller inputs 510 are directed through the letter of credit generator 500 to the encumbrance locator 600 for verification of the buyer's encumbrance in favor of seller. Once the seller provides the service or product to the buyer, the buyer will authorize an encumbrance release 540 procedure.

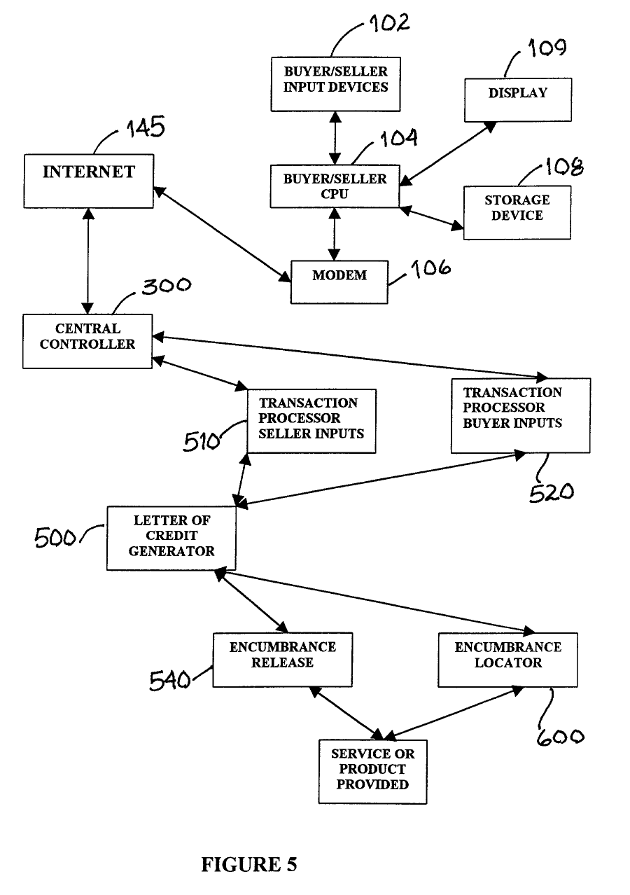

Referring to FIG. 5, once the seller has struck a deal with the buyer, the seller needs to confirm future payment upon shipment of product or the providing of services is accomplished. This is done through an interactive letter of credit created by the parties and guaranteed by the automatic operation of the system.

To determine that an encumbrance against the CCmoney balance of the buyer in the amount of the purchase order, the seller activates on his selling screen and locates the encumbrance. A digital signal is then transmitted to the sellers CPU 200 which, in turn, transmits the signal to the seller modem 240 and to the seller storage device 230. The action is communicated through the Internet 145 to the Central Controller CPU 300 which directs the input to the transaction processor 350, the letter of credit generator 500 and the encumbrance locator 600. The encumbrance locator 600 identifies the seller's CPU 200 and authorizes and sends back a search parameter screen or a routine to determine the identity of the buyer's encumbrance.

As a result, the buyer's display 110 indicates that the function button has been activated and the search parameter screen appears. The seller uses his input device 220 to respond to questions on the search parameter screen and communicate those responses to the buyer CPU 100 which replicates the above described digital communication and processing path. The encumbrance locator 600 then sends back confirmation of the buyer's encumbrance and the system prevents the buyer from using the encumbered portion of the account balance for any purpose other than payment to the seller. Also, the encumbrance locator 600 interacts as necessary with the letter of credit generator 500, the transaction processor 350, the Central Controller CPU 300 and its storage device 335.

After the seller has delivered the bargained for goods or services, the buyer can release the encumbrance covering the cost of the goods or services thereby immediately effecting payment. Alternatively, if the goods or services are not delivered completely as agreed the buyer and seller, acting together, can modify the encumbrance and then the buyer can release the modified encumbrance. In the rare case where the seller acts fraudulently or fails completely to deliver, the buyer has judicial recourse or can apply to the system manager who will open an investigation and may remove the encumbrance based upon the findings of that investigation.

For example, the input device 120 is used by a buyer in a transaction to communicate with the Buyer CPU 100. To release an encumbrance against its CCmoney balance, the buyer accesses the system and activates the release encumbrance button on his buying screen appearing on display 110. Activation of the release encumbrance button causes the buyer CPU 100 to access the storage device 130 to identify all open encumbrances. The CPU 100 then causes all the open encumbrances to be listed on the display 110. The buyer then uses the input device 120 to select the encumbrance to be released. A digital signal thus transmitted to the buyer CPU 100 causes the record to be modified in the storage device 130 and the modem 140 to communicate through the Internet 145 with the Central Controller CPU 300.

The Central Controller CPU 300 then causes the transaction processor 350 to initiate and implement a check of the letter of credit generator 500, causing the encumbrance release system 540 to transfer the released encumbrance CC balance, to debit the CC account of the buyer and to instantly credit the CC account balance of the seller. Confirmation is then conveyed back through the system to buyer.

As part of opening a new CC money account or increasing the balance in a previously opened account, as illustrated in FIG. 6, the system uses the funds processor 340 as a means for accepting delivery of local funds and for trading of these local funds. Funds traded are deposited in reserve currency accounts at participating banks through the user's mirror traded currency checking account. If the user does not have a mirror checking account for the currency to be traded, the trade can take place but the specific country Cyber Credits received would be trapped in the CCmoney system and not redeemable in the real banking system. Cash reserves created because of such a trade would be deposited in a participating charter (international money center) bank. The funds processor 340 has an input device for recording these deposits in the Central Controller CPU 300 storage device 335 and confirming the CCmoney credit back through the system to user CPU 104 and its storage device 108.

User input device 102 is used to respond to the interactive Internet web page 160 and electronic interview 170 sent back by the new accounts routine through the Central Controller CPU 300, the Internet 145 user modem 106, the user CPU 104 and user display 109. Funds transfers can also be effected by telephony or using input device 102 when the user has separate electronic funds transfer capability.

The new accounts generator 900 assigns a unique address and identifier code to the new account. Funds received and entered by the funds processor 340 are associated with the account address and identifier code and recorded in the Central Controller storage device 335. While the identifier code is assigned randomly and unknown except as digital entries in the user storage device 108 and the Central Controller storage device 335, the account address is selected by the user as an easily remembered set of words or names fitting a fixed pattern. This allows users to identify each other. The identifier code is a validation key to the encryption system.

Central Controller seller and buyer user inputs 410, 420 which do not constitute a request for deposit of local funds cause the transaction processor 350 to direct the transaction to the letter of credit generator 500 as shown in FIG. 5. However, when the Central Controller user input 410, 420 receives a demand for money 430, inputs are transmitted to the transaction processor 350 which causes a routine to be activated. This routine verifies authorization, verifies that the user's unencumbered CC balance is sufficient to cover the cost of the funds to be transferred, verifies that the banking link information of the user is adequate to handle the requested transfer and that there are local funds requested available to the system's local link to a participating bank 440. If enough local money is not available for the transaction, the transaction processor 350 automatically generates an order to purchase the needed currency and transfers the same to the local participating bank 440 acting as the transaction disbursing transmitting agent.

Accessing the user input device 102, the user responds to the interactive internet web page 160 and electronic interviewer 170 portion of the new accounts routine. Responses are communicated to the user CPU 104 which directs signals the user storage device 108 and the modem 106. After funds are deposited to establish the account, the new accounts generator 900 requests the user to select an address. This request is transmitted through the Internet to the modem 106 and the user display 109. The user indicates the desired address using the input device 120. This information is conveyed up stream to the new accounts generator 900. The requested address is then compared to all other addresses contained in the storage device. If the address is available, it is assigned to the new account and confirmed downstream to the user.

The following are examples are illustrative of how the system will work from the perspective of a user.

### EXAMPLE 1

A steel warehouse business in Chicago, Ill. sells a load of steel to a new customer in Houston, Tex. The sale price of the load of steel is $125,000. Both the seller and the buyer maintain CCmoney accounts and the buyer has sufficient Cyber Credits (CC) available in purchasing power. After a telephone discussion, the terms of the transaction are recorded and acknowledged over a secured Internet connection. The buyer then logs into his CCmoney buying page and enters the name and CCmoney address of the seller. He enters his or her authorization identifier (fingerprint, signature, password, etc.) and encumbers the account for the specified amount, namely 125,000 CC, which is equivalent to $125,000. He then transmits an access/transaction code to the seller. The seller then can log onto his CCmoney selling page and can verify that the agreed encumbrance has been made to the buyer's account in the seller's favor. Once verified, seller acknowledges the order and its terms to buyer. When the buyer in Texas receives the shipment, the buyer accesses his CCmoney account and releases the encumbrance, which will instantly transfer 125,000 CC to the CCmoney account of the seller in Chicago.

The entire transaction is encrypted automatically at each stage by the CCmoney system. Once encumbered, buyer can not unilaterally remove the encumbrance. The encumbrance can only be removed or changed by agreement of the parties, a court order, or, in the case of fraud, investigation by CCmoney. The seller will have an incentive to ship on time and as specified in the order to gain control over the Cyber Credits set aside for payment and will have the peace of mind from knowing that he probably will be paid. On the other hand, the buyer will have the peace of mind from knowing that, if he is not satisfied with the shipment, he can prevent payment to the seller until he is satisfied.

Central Control provides customer service (CC customer service) should buyer or seller default on any of their obligations. For example, if a buyer carelessly forgets to release an encumbrance or intentionally as a matter of practice fails to release encumbrances, a seller can contact a CC customer service representative. Upon investigation, the CC customer service can cause the release of the encumbrance and close the account of the buyer. On the other hand, if a seller habitually ships goods late or not to specification of the order, CC customer service provides assistance to the buyer. If upon investigation, CCmoney detects a pattern of abuse, it may adjust the encumbrance payable to the seller and close the account of the seller. As time passes and the CCmoney system becomes widely accepted as a medium for handling the financial portion of business transactions, the threat to sellers and buyers of a potential expulsion from the system will encourage more honest dealing.

### EXAMPLE 2

A service provider (doctor, lawyer, CPA, etc.) meets with a new client and requests a retainer of $500. The client advises that he has a CCmoney account and would prefer to encumber the account for 500 CC. The client can then pass his CCmoney debit card through a card scanner in the professional's office, enter his PIN, and press the encumbrance (credit) button and enter the agreed-to amount of 500 CC. Although the service provider would probably have preferred to have the cash flow from advance payment, such encumbrance acts as an incentive to timely provide the complete contracted-for work. For a service business, matching payment with completion imposes important control over the profitability of the business. The client feels more secure knowing that he has provided a carrot to encourage quick performance on the part of the service provider. When the service provider completes his tasks or presents the completed work to the client, the client again passes his CCmoney debit card through the scanner and releases the 500 CC encumbrance thereby instantly transferring this sum to the service provider's CCmoney account.

It should be noted that in both examples neither seller had to issue an invoice or wait for a check to be received or clear. The buyers did not have to write a check. Paperwork was dramatically reduced.

Some of the advantages of the CCmoney system are:

1. Instantaneous Cyber Credit (virtual money) and secure payment services linked to checking.

Cyber Credits are in two forms. Local Cyber Credits (LCC's) are, for example, Israel Cyber Credits (ICC's) backed by NIS's, French Cyber Credits (FCC's) backed by French Francs, British Cyber Credits (BCC's) backed by British Pounds, etc. International Cyber Credits (CC's) are backed by U.S. Dollars. Because Cyber Credit transactions are merely accounting entries, they are instantaneous Virtual Money Transfers (VMT's). They have the effect of netting money transactions. This netting requires the system to make only Real Money Transfers (RMT's) within the bank and single end of day transfers between banks. When CCmoney customers buy or sell Cyber Credits, they decrease or increase their checking accounts. Each CCmoney system customer's checking account is information linked to its CCmoney Cyber Credit and CCmoney Omnibus Reserve Account (OR/A)—also referred to simply as trust reserve accounts—for, at least, the local currency and U.S. dollars. When, using the CCmoney system Internet site, a customer transfers money from his checking account (local or dollar account) to buy corresponding Cyber Credits, the system causes the amount of the transfer to be debited to (decrease) the Customer's checking account and credited to (increase) the appropriate OR/A (CCmoney auto directed bank trust account) at the customer's bank. At the same time, on the books of CCmoney, the customer's Cyber Credit account is credited (increased) for the corresponding number of Cyber Credits and the CCmoney Cyber Credit (LCC or CC as appropriate) Aggregate account is debited (increased) for that amount. When a customer of a participating bank, transfers Cyber Credits to its checking account, the appropriate OR/A account at the customer's bank is debited (decreased) for the amount of the transfer and the customers checking account is credited (increased). At the same time, on the books of CCmoney system, the appropriate Cyber Credit Aggregate account is credited (decreased) for the corresponding Cyber Credits and the customer's appropriate (LCC or CC) Cyber Credit account is debited (decreased). These extra accounting entries mirrored on the books of CCmoney system create Internet currency that allows customers to transact business instantly and directly with each other while using a minimum of bank clearing services.

For purposes of illustrating how the system works, Customer A, decides to make payments using its LCC account. When Customer A debits (decreases) its checking account on the books of the bank for the number of local currency units corresponding to the total number of LCC's required to make its payments, Customer A's LCC account is credited (increased) for the same number of LCC's on the books of CCmoney, the LCC Aggregate account is debited (increased) on the books of CCmoney, and the CCmoney OR/A for local currency is credited (increased) on the books of the bank. When Customer A makes its payments with LCC's, its LCC account on the books of CCmoney system is debited (decreased) for the corresponding number of LCC's needed to pay Customer A's bills and the various payees' LCC accounts only on the books of CCmoney system are instantly credited (increased) for the payments received. Assuming the payees all convert the increase in their LCC accounts to checking balances at their respective banks, there will be a decrease in the OR/A at each of these respective banks. The total decreases are equal to the RMT of Customer A with its bank's CCmoney OR/A. It is not likely that such transactions will cause a deficiency in the OR/A of a participating bank. If, however, there is a deficiency in the OR/A of a payee bank, the system will transfer, before the start of business the next day, a sufficient amount from the OR/A of a Charter bank to the OR/A of such payee bank. In any event, each OR/A of a participating bank will be balanced with the total Cyber Credits of its customers currency by currency. The cost of transferring funds to thus balance OR/A's are charged to the recipient bank's Cyber Credit account. Banks can avoid this charge be electing to have balancing funds credited to its Cyber Credit account. In effect, this is a transfer from the bank's capital cash to its CCmoney OR/A. Even in a worst case scenario, there is a substantial reduction in RMT's between banks. Consider the following worst case scenario. If Customer A paid 100 bills and each of the bills had a payee at a different bank who immediately converted the LCC's to its checking account, such conversions cause a deficiency in the OR/A's of the payee banks. Normally 200 RMT entries would have to be recorded, one to debit the checking account of Customer A for each payment and one to credit the checking account of each payee. However, as to Customer A, there are only 102 RMT entries, one to transfer money from Customer A's checking account to the OR/A at its bank, one to remove that amount from the OR/A at Customer A's bank to cover the total LCC's paid to the payees, and 100 to distribute that RMT to the various payee banks' OR/A's to cover these assumed deficiencies. This reduces RMT bank-clearing entries by 99. There are 102 VMT's on the books of CCmoney. However, these are completely automatic, and require no intermediary clearing or paper handling as in the case of checks or electronic funds transfers (EFT's) which are in effect electronic drafts on bank accounts requiring more than 24 hours of clearing time. The 102 VMT's are instantaneous and the 102 RMT's take no more time to clear than the EFT's. In a best case scenario, most of the payees will be concentrated in just a few banks and they will use LCC's to pay their bills and will not necessarily convert LCC's to checking deposits. Also, rarely will a conversion from Cyber Credits to checking cause a deficiency at the payee bank. As the CCmoney system matures, such deficiencies will become less and less probable. It is the goal of CCmoney to eventually eliminate checks and EFT's as a means for making payments. Fees paid by payees will be no more than what they now pay. However, by opening a Cyber Credit account and therefor accepting Cyber Credits, payee will have quicker access to finds. This will encourage payees to accept Cyber Credits and help the viral spread of the CCmoney system system. Participating banks will have Cyber Credit accounts and their share of fees earned will be automatically deposited by the system in the bank's Cyber Credit account.

2. Instantaneous Cyber Credit (virtual money) transfers to replace wire transfers.

Just as wire transfers can be made in a number of currencies, for example when funds are transferred to a recipient or for other business reasons, LCC's can be transferred internationally. However, most international transfers of Cyber Credits will be the more universally accepted dollar backed CC's. International transfers of Cyber Credits will be instantaneous and therefor preferred over wire transfers and will cause a reduction in the wire transfer costs of banks. Banks will be able to charge comparable prices for these transfers but will be charged a fixed fee per transfer by CCmoney system thus converting a cost center into a guaranteed profit center.

3. Reduction of check clearing transactions through virtual money transfers and restriction of real money transfers to daily augmenting of Omnibus Reserve Accounts.

Over time instantaneous in-country Cyber Credit payment transfer services will reduce the bank's cost of check clearing by reducing the number of checks exchanged between banks and increasing the electronic debiting and crediting of accounts within a bank as when money goes in and out of the CCmoney system Cyber Credit accounts from and to checking accounts. Each day that there is a net increase in checking balances at a bank caused by CCmoney customer conversions out of Cyber Credits that can not be covered by the OR/A at the bank, reserves may be transferred by automated interbank transfer. As the CCmoney system spreads virally throughout the world economy, the number and magnitude of RMT's will diminish and the volume of VMT's will increase correspondingly. Bank clearing operations will eventually be minimized serving only those people who do not have an Internet connection. Given that the costs of these Internet connections are likely to be dramatically reduced in the near future and access is likely to be through inexpensive ubiquitous devices, very few people will use checks and pre-authorized debits thus reducing bank clearing transactions.

4. Creation of excess reserve account balances (in effect non-interest bearing balances) allowing Charter banks to make more overnight loans and earn more interest income.

When a bank facilitates the creation of a CCmoney system account, no money leaves the bank. Instead the CCmoney system dollar and local currency Omnibus Reserve Account (OR/A) is credited (increased) on the bank's books, and the appropriate Cyber Credits purchased are recorded on the books of CCmoney system. The OR/A balance only changes as a result of CCmoney system transactions that have a net effect on checking accounts. As Cyber Credit transactions increase and holding Cyber Credits becomes preferred, these OR/A balances will become as stable as savings accounts but will not pay interest to the CCmoney system. Also the stability of the OR/A's will allow banks to lend out more money thereby earning more interest income. So, the banks will benefit by saving interest costs on steadily increasing stable reserves and being able to earn more interest income by increasing its loans to customers. These OR/A's will be neutral with respect to central bank money supply operations. For example, in the United States, the Federal Reserve Open Market Committee (FOMC) can still decide to buy or sell U.S. government bonds. If it buys, this will put funds in the hands of sellers bringing new deposits to the U.S. banking system. The U.S. banks will still be able to lend these new funds out creating new money expansion equal to the inverse of the deposit reserve ratio times the amount of the cost of such bonds purchased. The converse is true when the FOMC sells bonds. When overnight interbank transfers are made to balance the OR/A's of participating banks with their respective customer Cyber Credits, funds will first be transferred to Charter banks, which are large participating international money center banks. This will allow the Charter banks to make more interest income from overnight lending operations.

5. Encumbrance transactions creating interactive letters of credit.

Encumbrance transactions will eliminate the administrative costs associated with letters of credit but will not reduce the revenues received by the banks.

6. Re-encumbrance transactions providing assurance of loan repayment.

Re-encumbrance transactions will increase profits to banks on loan activity by reducing the number of loans classified as substandard or non-performing. In other words, the reserves for bad debts of the banks will be reduced. Re-encumbrance forces the payment of funds received on a financed customer sale to be paid to the bank directly. This eliminates the possibility that a loan customer may forget, be unaware or intentionally avoid making a loan payment that is due.

7. Currency exchange utilizing bank currency trading and transfer facilities.

When a CCmoney system customer needs foreign currency, the customer's LCC or CC account will be used to buy foreign Cyber Credits at the exchange rate then in effect between the two underlying currencies. The customer's foreign Cyber Credit account will be increased or credited. Then the customer can convert the foreign Cyber Credits to its linked checking account in its foreign country bank. To avoid any risk of currency translation, the CCmoney system causes OR/A units to be sold and purchased before the VMT entries are recorded. A bank makes money on each foreign currency transaction directed to it by the CCmoney system system. Although the bank will share its spread on CCmoney system currency trades with the CCmoney system, the automated entry of these trades and transfers will reduce trade costs in excess of the CCmoney system share of the spread. Also because of the acceleration caused by CCmoney system in the world economy, the demand for currency trading services should grow.

8. Yellow page (electronic business) listings to augment bank customer connectivity.

CCmoney system's electronic business directory of participants will increase the connectivity between bank customers and will give all banks worldwide reach. It is difficult to determine the effect of this service on the profitability of banks; but, since banks are competing to bring convenience and efficiency to customers, it is reasonable to assume the convenience of connecting CCmoney system account holders will open new profit opportunities for banks.

Various functions and operations of the CCmoney system, supplemental to the descriptions above, are summarized below:

1. Open Account Increase Account, Decrease Account

To open a CCmoney system account, a potential new user calls his local banker. If the local banker does not know the potential new user, he may require the user to come in, fill out a form and present identification. Once the banker knows that he is dealing with one of his customers, he then can request a Temporary Access Number (TAN) from his correspondent bank by secure electronic communication supplying pertinent information which would allow the CCmoney system to verify that the TAN is legitimate and not compromised. (The TAN is not disclosed to anyone other than the new customer. It is kept secret by the system.) If the local banker's correspondent bank is not a franchise bank of the CCmoney system, the correspondent bank would relay the secure electronic communication up the banking chain until it gets to a CCmoney system franchise bank. This participating bank accesses a special part of the CCmoney system which identifies the authority of the participating local banker and assigns a TAN and advises the originating banker by separate communication that a TAN has been assigned to his customer. The originating banker informs his customer that a TAN has been assigned and he can now open a CCmoney system account. The customer then enters the CCmoney system site and goes to the level that will allow the new user to open a CCmoney system account. When he clicks on the button to open a new account, he will be asked information which has been supplied by his local banker up the banking chain to get the TAN. Once the system concludes that the user is entitled to know the TAN, it will allow him to continue opening an account. Should the new customer have to interrupt the process, the system will disclose the TAN to him so after just a few questions, the new user can pick up where he left off.

In the process of opening a new account, the new user will be asked a series of questions which will allow the CCmoney system to challenge his identity in the future or perhaps identify the new user as a possible money launderer or other type of fraud. If he is considered suspect according to the criterion of the system, he will be asked to call a toll free number or wait to be contacted by a CCmoney system customer service representative. The new user may request someone speaking a language other than English. Customer service representatives will be trained in fraud detection and will have the authority and limited access to override the computer. Once the new user gets past this interview process, the user will be given an opportunity to select a personal pass word which will only be known to the user and will take the place of the TAN.

The user can then go to a screen that will allow him to debit (decrease) his bank checking account in real time. The CCmoney system will credit (increase) the OR/A of CCmoney system for the amount of money debited to the user's checking account and the system will then report a balance of Cyber Credits of equal number to the new user. The OR/A will be maintained at the user's bank. This account is a checking account for which no checks have ever been printed, receives no interest, and usually is not insured by the FDIC except for a small portion of the account balance. If the user is not a U.S. user and does not have a dollar checking account, the user can indicate how much of the local currency it wants to convert into CCmoney system CC's (dollar backed Cyber Credits) or how many CC's he wants for opening the account. The CCmoney system will then seamlessly place an order with an associated currency trader that more often than not will be the participating franchise bank. The trader and participating bank will charge a spread for this service which along with the number of Cyber Credits (also U.S. dollars deposited in the CCmoney system OR/A) purchased will be disclosed to the user on a screen that looks as follows:

$$\begin{matrix}Local currency sold & xxxxx . xx \\ Spread charged & xx . xx \\ Total Charged to checking & xxxxx . xx\end{matrix}$$

When the new user established his account, he also may have had other checking accounts at other banks around the world in various local currencies. In the first or subsequent iteration of the CCmoney system system, he will have the ability to link these other non-primary accounts to his CCmoney system account. In all cases, the new non-U.S. CCmoney system account holders will have, at least, two Cyber Credit accounts, a LCC (local Cyber Credit) account and a CC (U.S. dollar backed Cyber Credit) account. Without a CC account, the ability of the customer to engage in VMT's internationally would be limited. By the same token, without a LCC account, the customer would not be able to engage in VMT's locally.

Once the user has established its account by purchasing Cyber Credits, it can increase its account balance by clicking on a button for the specific purpose of increasing its CCmoney system balance. Using this routine, the user would essentially go through a process that would replicate the initial deposit where its linked checking account was debited (decreased) and the CCmoney system OR/A was credited (increased). Also the user may reduce its CCmoney system account balance by clicking on a button for the specific purpose of decreasing its CCmoney system account balance. In this routine, the user essentially goes through a process that is the reverse of increasing its Cyber Credit balance. When decreasing its CCmoney system account, it may designate what currency it wants and in what linked bank account the money is to be deposited.

The last thing a new user does when establishing his account is to pick an access name of not more than 25 characters by which to be addressed by other users. This identifier will also be indicated under his electronic business listing.

2. Encumbered Purchase and Sale Transaction

When a user-buyer strikes a deal with any provider of goods or services anywhere in the world who also maintains a CCmoney system account, and buyer wants to give the seller assurance that the seller will be paid the agreed price if the goods or services are supplied as specified, he will encumber his CCmoney system account for the amount of the purchase. Knowing the user-seller's access name, the user-buyer goes to his buying screen. The buying screen gives the user-buyer the option to write a purchase order on a form that can be designed by the user-buyer. The purchase order does nothing except serve as a reminder to both parties of what the arrangement is. After the user-buyer writes the purchase order, he can then write an encumbrance in favor of the user-seller. Alternatively, the user-buyer can just write an encumbrance by filling in information on a template provided by the CCmoney system system. He would click on the button, “Write Encumbrance” and provide the sellers name and the amount of the transaction. Before the user-buyer can exit the “Write Encumbrance” transaction template, he will be warned that the encumbrance can only be changed with the approval of the user-seller and asked if he is sure he wants to proceed. When the user-seller goes to his selling screen only knowing the access name of the user-buyer, he can check to see if the encumbrance has been written. If the user-buyer wrote a purchase order, the user-seller will be able to read the purchase order and print it out if he wants. At this point, the user-seller can acknowledge the order on a standard form or one specifically designed by the user-seller. The purchase order and acknowledgment process can be completed before the user-buyer actually writes the encumbrance.

Typically, if the transaction is a repetitive or simple order, the user buyer will write the purchase order at the same time that he writes the encumbrance. If it is more complicated, the user-buyer will elect to write the encumbrance after he receives the acknowledgment of the user-seller. Once the user-seller sees that an encumbrance for the amount of the purchase has been written, he then ships the goods or provides the service. Assuming the goods or services were provided as agreed, the user-buyer clicks on the “Release Encumbrance” button, finds the access name of the user-seller and the amount and date of the relevant purchase and highlights it. He then clicks the button, “Release”. Instantly user-buyer's encumbered Cyber Credits are debited (decreased) for the amount of the purchase and the free Cyber Credits of the user-seller are credited (increased). In the event the goods or services are not delivered as agreed, the user-buyer and the user-seller either come to an agreement or go to court. At any rate, until there is agreement, the encumbrance just sits as is. If there is an agreement, the user-seller can reduce the encumbrance in his favor and provided the user-buyer releases the reduced amount the excess encumbered amount is returned to the user-buyer's free Cyber Credit account.

CCmoney system has an established complaint and reconciliation system that all participants must agree to be participants in the system. If a user-buyer or a user-seller registers a complaint with the CCmoney system alleging fraud, CCmoney system personnel will activate the reconciliation system to settle the accounts in dispute. If CCmoney investigators find fraud, they can institute a procedure subject to an approval process that will undo the encumbrance or adjust it. They can also recommend the closing of the offender's CCmoney system accounts. Generally encumbrances will be released without modification. Also, if a user-buyer habitually uses his position to force user-sellers to reduce their price after the fact and the user-sellers complain, CCmoney system may cancel the user-buyer's account and bar that user-buyer from opening another account. On the other hand, if a user-seller habitually tries to coerce release of an encumbrance before shipment or provision of service, he may be barred from having a CCmoney system account.

3. Re-encumbrance of an Encumbered Transaction

It is possible that a company receiving an encumbrance for a sale will have to pledge and assign the encumbrance to its bank or its creditor either as a routine matter to comply with a line of credit extended by its bank (or another lender), or if the lender is financing its sales on a transaction by transaction basis then to secure an individual sale loan. Usually this will be done because of some revolving line of credit. However, it may involve an obligation to a supplier to seller of goods such as raw material for manufacturing. This is very important to the relationship between the seller and his lender or supplier because it provides assurance to that party that he will be automatically paid. Very often collection of a receivable by a company does not necessarily end up being used to pay a lender. There are generally three reasons for this kind of failure 1) the borrower's accounting system does not automatically separate collections belonging to a lender from those that are financed by the company, 2) the money is urgently needed to pay some other obligation, and 3) someone just forgot to pay the lender on time.

To effect a re-encumbrance both the bank or lender and the seller of products or services must have a CCmoney system account. An encumbrance can be re-encumbered any number of times. So a lender who needs to discount a loan can do it just by re-encumbering one or several encumbrances re-encumbered in its favor. When the buyer releases an encumbrance, the CCmoney system will trace through the re-encumbrances and deposit the re-encumbered amount of Cyber Credits in the Cyber Credit account of the last user-lender to receive the encumbrance through assignment by re-encumbrance. The process is very similar to the encumbrance process. Knowing the user-lender's access name, the user-seller goes to his borrowing screen. The borrowing screen gives the user-seller the option to re-encumber any encumbrance written in its favor. All the user-seller has to do with respect to any encumbrance to be re-encumbered is to enter access name of the party to receive the encumbered funds and the amount. Once the user-lender checks its lending screen and verifies that the encumbrance has been re-encumbered in its favor, it can transfer Cyber Credits to the borrower, put funds in the borrower's checking account or permit the borrower to draw against its line of credit.

4. Currency Trades

When a CCmoney system customer needs cash delivered to a foreign bank account, or needs foreign Cyber Credits to facilitate additional encumbrances to suppliers or to pay foreign bills in-country or transfer Cyber Credits internationally, the CCmoney system customer will either have to buy foreign currency with Cyber Credits or buy foreign Cyber Credits with its local currency.

By clicking on the currency buying screen, the CCmoney system customer can order Cyber Credits in his account be sold until the amount of a designated traded foreign currency is purchased. Alternatively, he can ask the system for a quote and order that the system sells a specific amount of Cyber Credits to acquire the designated currency. After buying the designated currency Cyber Credits, the CCmoney system customer can then order that the purchased foreign currency Cyber Credits be deposited in its foreign bank account previously set up for this currency.

To illustrate how the CCmoney system would process a typical currency trading transaction, suppose Customer A in Israel wants to use his ICC account to buy French Francs and has a French Franc checking account in a CCmoney system participating bank in Paris. Customer A goes to the Currency Purchase screen and clicks on Purchase, then on French Francs, then on RMT, and finally enters the amount of French Francs requested. The CCmoney system responds by placing an order to buy the number of French Francs requested by selling Israeli Shekels at market with the designated trader for Customer A's bank. To work within the CCmoney system system, the currency-trading agent will have a CCmoney system account for each currency it trades. When the trader completes the trade, its system will debit (decrease) its FCC account for the number of French Francs sold net of its spread or commission. The FCC account of Customer A will be credited for the same number which will also be the number of French Francs requested by Customer A. Simultaneously the ICC account of Customer A will be debited (decreased) for the gross number of Shekels sold and the ICC account of the trader will be credited (increased) for the same number. If Customer A, debits its FCC account to increase or credit its French Franc checking balance at its Paris bank, the French Franc OR/A maintained at the Paris bank will be debited. If this causes a deficiency in the OR/A at the Paris bank, French Franc OR/A funds at another bank will be transferred to cover the deficiency. Alternatively the Paris bank may purchase FCC's with its capital thereby avoiding Interbank transfer charges and increasing the CCmoney system OR/A. The CCmoney system always maintains a unit of currency in some OR/A in a distributed network of banks around the world for each of that currency's Cyber Credits in circulation.

Banks and currency trading firms would like to automate their trading operations to the extent possible. Today because a bank employee or other human agents must intermediate between the parties to a trade, automation is hindered. A bank's computer system, at the maximum, can only net priced buy and sell orders within the bank's system with the net order going to a currency-trading desk. Of course, market orders can not be netted. The CCmoney system would aggregate and net priced orders to buy and sell instantaneously on a worldwide basis thereby reducing transactions and costs. However, the normal spreads charged by the bank associated with the order source would still be credited to the Cyber Credit account of that bank less CCmoney system's share and less the bank's pro-rata share of a distributed charge back for the spread charged to CCmoney system for making the net trade through currency trading agents. The computations and transactions would be recorded instantaneously. This feature effectively over time will reduce the cost of trading for banks by eliminating many thousands of currency trading personnel. It is an economy of scale that only the CCmoney system can offer. A single bank by itself no matter how large can not realize this savings. The savings realized through more efficient netting of priced buy and sell orders is part of the economic imperative of the CCmoney system.

5. Payment Transactions

When a CCmoney system user wants to make payments, he clicks on file and then on his preferred accounting package, a custom accounting package which has been integrated by a software developer or programmer or one of the two generic packages which has been pre-integrated by CCmoney system. The two generic packages offered by CCmoney system are Quicken or QuickBooks. These packages and most custom packages allow a payer to make payments individually or in vouched batches. Payments can only be made to payees who have at least one CCmoney system account. Once the payer knows the access name of the payee, he can make payment by keying in the amount of the payment, the access name of the payee and then clicking on the “pay” button. The payer can also reference a batch to be paid in the accounting package. If there are sufficient Cyber Credits in the payer's CCmoney system account, the system will instantly credit the Payee's CCmoney system account and debit the Payer's account for the payment amount of Cyber Credits. If there are not sufficient Cyber Credits in the payer's account, CCmoney system will indicate the amount of the deficiency and give the payer the option to transfer funds from the payer's linked checking account. Once payment is made, the payer has instant confirmation in his system.

The main reason for a seller to accept payment in Cyber Credits is to eliminate the cost and delay of having to receive checks and other electronic payments. To the extent the seller gets paid in Cyber Credits, it can eliminate debit clerks and deposit clerks and gain the time value of money benefits from quicker use of funds. The payment transfer service will be free to payers and charged to the banks at a rate substantially below what they are now receiving from payees using the debit facilities of the bank. The amount charged to the banks will be less than they save in costs associated with the banks draft debit system. Therefor banks will experience an increase in profits.

6. International Transfers

This procedure is identical to that for payment transactions. Transactions are convenient, instant and eliminate all bank intermediary personnel. When a CCmoney system user wants to make an international transfer, it clicks on file and then on its preferred accounting package, a custom accounting package which has been integrated by a software developer or programmer or one of the two generic packages which has been pre-integrated by CCmoney system (Quicken or QuickBooks). These packages and most custom packages allow an international transferor to make transfers individually or in batches. Transfers can only be made to transferees that have a CCmoney system account. Once the transferor knows the access name of the transferee, it can affect the transfer by keying in the amount of the transfer, the access name of the transferee and then clicking on the “transfer” button. The transferor can also reference a batch transfers in the accounting package. If there are sufficient Cyber Credits in the transferor's CCmoney system account, the system will instantly credit (increase) the transferee's CCmoney system account and debit (decrease) the transferor's account for the amount of Cyber Credits transferred. If there are not sufficient Cyber Credits in the transferor's account, CCmoney system will indicate the amount of the deficiency and give the transferor the option to transfer funds from the transferor's linked checking account. Once transfer is made, the transferor has instant confirmation in its system.

7. Franchised Bank Reports

Franchised banks need to be able to check on the revenues earned through their customers' transactions using the CCmoney system system. On a transaction by transaction basis, participating banks and CCmoney in each transaction are automatically credited in their respective Cyber Credit accounts with the Cyber Credits earned because of their customer's transaction. These amounts are numerous and may be small and it would be a burden on the banks to analyze the transactions one by one and then classify them so they could be recorded on the books of the bank. CCmoney therefor automatically classifies each transaction and reports the totals for each type of transaction to the relevant bank each day. Additionally the bank will be able to get these classified totals by the week, month and year. Each bank will have an access window that it can bring up through its CCmoney system web site. On this window it can select daily, weekly, monthly and annual accountings of its transactions. If the bank does not like the classifications in the default configuration, it can select transaction types and assign classification titles to each transaction type and the system will track transactions as designated. Banks will also be able to call up any specific transaction and all details associated with that transaction. The report function will be maximally designed to accommodate the customized security protocol of each bank. CCmoney will also provide audit tools to help banks audit CCmoney system transactions.

8. Electronic Business Listings

When a user selects an access name, certain information provided by the user in the sign-up process is automatically added to CCmoney system electronic directory 315. The information in a typical listing will include:

Legal name of user

Main address

Phone numbers by standard department (Sales, Purchasing, Customer Service, and Accounting)

Fax Numbers, and

Appropriate E-mail addresses.

People doing business using the CCmoney system will want to do business with others using the system. By selecting electronic directory on their access screen they will be able to look up companies using standard directory classifications. The CCmoney system directory will allow a purchaser to post a purchase inquiry automatically to the CCmoney system sites of all or selected users in a single classification. Users looking for sales opportunities, can check these inquiries on their CCmoney system sales information screen. Additionally users can contact each other using the phone numbers, fax numbers and e-mail addresses provided to them through the CCmoney system directory. A user in the process of completing a transaction, who does not know the access name of the transaction counterpart user, can find the access name knowing only the listed legal name of the counterpart user, its address, one of its phone numbers, one of its fax numbers or one of its e-mail addresses. By typing in one of these descriptors, the entire user access name information appears for directory will also contain a white page section for non business users listings. Individual users will also have their names, phone number, fax number and e-mail address listed if they desire. However, individuals may want to have unlisted access name for privacy and security purposes. All information will be standardized in format to make use of the directory visually easy to use.

It is evident from the foregoing that there are many additional embodiments of the present invention which, while not expressly described herein, are within the scope of this invention and may suggest themselves to one of ordinary skill in the art. For example, the system described herein will allow a user to provide all services currently available to him from financial institutions, credit card companies, stock brokerage accounts, etc. Besides the user having the ability to debit his electronic account, he can also authorize other parties to debit the account, for example for periodic approved withdrawals, (ie, mortgage payments, credit card charges, monthly stock purchase plans, etc).

Also, the electronic accounts can be directed to automatically, or on demand, convert electronic funds into hard currency and transfer that currency from said account into checking or savings accounts or other interest bearing or income generating accounts such as money market accounts. While the system is described as tied to participating banks, credit card companies could replace the bank and the electronic account could be within or supplemental to the users credit card accounts. Likewise, brokerage houses and commodity trading institutions could serve the same function as the participating bank.

Also, while described as utilizing the Internet, it is broadly contemplated that any wired, optical or wireless system can be used in the same manner as described. Operationally, there is no reason why the system can not be implemented using a high speed optical system, a cellular net or satellite based data transmission systems.

The records of a user transactions within the system are readily integrated into such users cash management and business accounting system. This enhances internal controls of the user's financial transactions and administration of purchasing and budgeting procedures while providing an automated audit trail and record keeping.

The system also allows, and is designed to work with a broad range of currently available and contemplated bio-sensitive and electronic keys. Examples of such keys which can be integrated into the user access equipment to allow unique identification of each user and minimize fraud and theft. These include, but are not limited to, electronic fingerprinting systems, retinal/iris scanning systems, biological material (DNA) patterning and voice recognition systems. Also contemplated are various electronic keys which can be carried by the user which can be programmed to interact with the user interface. Thus, access to the system can be limited strictly to the individual carrying the electronic key or identified by the bio-indicator.

It is therefore intended that the invention be limited solely by the appended claims.

I claim:

1. An electronic funds transfer system comprising:
a central controller CPU in electronic communication over the Internet with system users and participating banks, said CPU programmed for on-line electronic funds monitoring said central controller CPU acting as a conduit for handling of transaction between system users, means at each participating bank, in communication with the central controller CPU, for buyers and sellers of goods or services to establish electronic funds linked to demand deposit accounts in said participating banks, electronic representations of currency purchased by said buyers from demand deposit accounts in said participating banks are deposited in said buyer's electronic funds account, where said electronic representations of currency have an original monetary value tied to a selected actual currency, a transaction processor module associated with said central controller CPU for processing interactive letters of credit, establishing and releasing, encumbrances on electronic funds deposited in said electronics funds accounts as financial transactions are entered into and consummated, and acting on instructions to pay identified obligations to other participants in said electronic funds transfer system a central controller storage module capable of storing information regarding all electronic on-line transactions between the buyers, sellers and the participating banks, and said central controller CPU being programmed to automatically balance electronic funds with their corresponding bank reserves through out the system on a selected periodic basis and, on a selected periodic basis issue reports of the status of such transactions, wherein the buyer in each transaction has control over the specification of electronic funds to be encumbered, the funds once encumbered are restricted from access by the buyer with the exception of release to the seller, unless released back to buyer by seller.

2. The electronic funds transfer system of claim 1 further including a new account module in communication with the central controller, said new account module accessible by users over the Internet, for qualifying new users and recording initial electronic representations of currency reserves deposited in support of electronic funds accounts at said participating bank.

3. The electronic funds transfer system of claim 1 further including voice or video communications capability between users and the central controller CPU.

4. The electronic funds transfer system of claim 3 further including electronic and person assisted dispute resolution and customer support services.

5. The electronic funds transfer system of claim 1 further including encryption, de-encryption and re-encrypting capabilities for recording and storing transaction records in a secure data storage facility, data stored for each transaction being accessible only by the participants of the transaction and an authorized operator of the electronic funds transfer system.

6. The electronic funds transfer system of claim 1 wherein the buyer and seller communicate over the Internet using the central controller CPU has an intermediary, the central controller CPU serving only to provide information services, a data link between users, record financial transactions, funds encumbrances and unencumbrancing thereof and to reconcile funds transfers on completion of a transaction to the satisfaction of the buyer and seller.

7. The electronic funds transfer system of claim 1 wherein electronic funds encumbered by a first buyer for the benefit of a first seller can be re-encumbered by said first seller for the benefit of one or more second sellers or funds providers to which said first seller owes a financial obligation, such that when the transaction between the first buyer and the first seller is completed and the encumbrance by the first buyer on first buyer funds is released, the released funds are automatically transferred, pursuant to instructions of first seller, to such one or more second sellers or funds providers, and prior sellers to said second sellers as so instructed by such participants electronically within the system.

8. A method for expediting business transactions over an electronic network between users of the network, said users encompassing buyers and sellers of goods or services and providers of funds, comprising:
establishing an electronically transferable fund-equivalent readily exchangeable over the electronic network by users of the system,
each user of the electronic network establishing an electronic funds account maintained the central controller CPU of the electronic network for receiving and dispersing the electronically transferable fund-equivalents owned by said user, the electronically transferable fund-equivalents in each users said electronic funds account being backed by hard currency reserves at the user's participating bank,
each user also establishing a unique address identifier through a central controlling CPU of the electronic network,
such that, when at least a first user and a second user of the electronic network enter into a business transaction which requires the exchange of funds,
a) the first user having an obligation of making a payment to the second user under the terms of the business transaction irrevocably, except for release of said encumbrance by the first user to the benefit of said second user, and other defined exceptions, encumbers fund-equivalents in said first user's electronic funds account for the benefit of said second user,
b) when said second user completes its obligations under the terms of the business transaction, said first user releases the encumbrance on the fund-equivalents in said first user's electronic funds account causing said find-equivalents in said first user's electronic funds account to automatically transfer to the electronic funds account of said second user,
an electronic record of all transactions regarding said fund-equivalents in said first user's and said second user's electronic funds account for said business transaction being recorded and stored in individual data memory units electronically connected to a CPU of said first user, a CPU of said second user and the CPU of the central controlling of the electronic network, the data memory unit electronically connected to the central controller functioning as a master data storage unit for all financial transactions of all users in said electronic network.

9. The method of claim 8 wherein one other defined exception includes an agreement, electronically transmitted, by said first user and said second user, acting jointly, to modify the terms of said encumbrance.

10. The method of claim 8 wherein one other defined exception includes an intervention, electronically transmitted, by an authorized agent of the network to settle a dispute between the first user and the second user regarding the proper completion of the business transaction.

11. The method of claim 8 wherein the central controlling CPU also provides to the users of the network access to an electronic directory of all users of the network, and access to each of said users through the electronic directory.

12. The method of claim 8 wherein the central controlling CPU also provides, on a periodic basis to each participating bank, reports of network activities of electronic accounts held by said participating bank.

13. The method of claim 8 wherein the central controlling CPU conducts at least a daily reconciliation of all transactions within the network and reports electronically to each participating bank involved in said days transactions the status of all electronic accounts within said participating bank.

14. The method of claim 8 wherein the central controlling CPU additionally provides to users, at the electronic direction of said user, the ability to transfer, at any time, electronically transferable fund-equivalents in an electronic account of that user to any other user of the network or to encumber such electronically transferable fund-equivalents for the benefit of any user of the network, irrespective of the existence of a business transaction.
